(19) United States
(12) Patent Application Publication
(10) Pub. No.: US 2012/0003956 A1
(43) Pub. Date: Jan. 5, 2012

(54) Real time sound/image capture and distibution to end recipient

(76) Inventors: Bill Austin, Simsbury, CT (US); Richard Dias, Simsbury, CT (US)

(21) Appl. No.: 12/803,580

(22) Filed: Jun. 30, 2010

(51) Int. Cl. H04M 11/04

(52) U.S. Cl. 455/404.2

(57) ABSTRACT

In one aspect when a security application stored in a memory of a portable device is initiated results in: determining location information of the device; actuating a microphone and/or a camera of the device to capture at audio and/or image data; and wirelessly sending to a pre-determined emergency service the location information and the captured audio and/or image data. In another aspect of the invention a private emergency service is operated using at least one server by storing an association of a calling phone identifier with a called phone identifier; receiving location information for the calling phone and audio and/or image data captured by the calling phone; using the received calling phone identifier to access the memory and determine the called phone identifier, and sending to the called phone a message comprising at least the received location information and the received audio and/or image data.

### TECHNICAL FIELD

The exemplary and non-limiting embodiments of this invention relate generally to wireless communication systems, methods, devices and computer programs and, more specifically, relate to real time or near real time sound/image capture at a mobile device and communicating that captured data to an end recipient.

### BACKGROUND

Mobile phones have become ubiquitous in most developed countries and are more often than not available to call for help when needed. Many common examples are those for which assistance is requested only after the incident has happened; the callers car has become disabled and the call is for roadside assistance, or the caller comes across a traffic accident and calls for emergency services at the scene of an accident. Time may be of the essence when medical attention is needed, but by necessity the automobile malfunction or traffic accident occurs prior to the call being placed.

When a mobile call concerns a criminal incident, typically it also is made after danger to the caller has passed, after a robber has left the scene for example. Real time calls while a crime is being committed may be considered as within two different categories; automated systems, and high-risk individual actions. Within the automated systems are fixed security systems that continuously transmit at least video to a remote monitoring location, and those which transmit some warning indication based on a sensed occurrence such as from a window/door open indicator or a motion sensor.

Apart from fixed systems there is individual action, for example a bank teller alerting police while robbers are still on the premises. The amount of risk to which the teller or other person exposes themselves in these situations depends on the nature of the actions and how secretive they are taken. One might consider the lesser risk extreme represented by the teller depressing a pre-installed button activating a silent alarm. Conversely, the higher risk extreme is represented by the teller manually dialing a 7 or 10 digit number to the local police precinct and verbalizing over the open phone line that a crime is in progress. The range between these two is of course quite wide.

What is needed in the art is a way to lessen the risk to individuals to report crimes that are still in progress, preferably in a manner that is not reliant on fixed security systems and that gives emergency personnel an improved opportunity to intervene for the benefit of the crime victim.

### SUMMARY

In accordance with one embodiment of the invention there is a method for operating a portable electronic device comprising, in response to a security application stored in a memory of the portable electronic device being initiated: determining location information of the device; actuating least one of a microphone and a camera of the device to capture at least one of audio and image data; and wirelessly sending to a pre-determined emergency service the location information and the captured at least one of audio and image data.

In accordance with another embodiment of the invention there is a computer readable memory storing a security application that when initiated result in the security application being executed by at least one processor. In this embodiment the executed security application results in actions comprising: determining location information of a host device storing the memory; actuating at least one of a microphone and a camera of the host device to capture at least one of audio and image data; and wirelessly sending to a pre-determined emergency service the location information and the captured at least one of audio and image data.

In accordance with still another embodiment of the invention there is a method for operating a private emergency service using at least one server. In this embodiment the method comprises: storing in a computer readable memory accessible by the at least one server an association of a calling phone identifier with a called phone identifier, the at least one server receiving location information for the calling phone and at least one of audio and image data captured by the calling phone; the at least one server using the calling phone identifier which is received with the at least one of the audio and image data to access the memory and determine the called phone identifier; and the at least one server sending to the called phone a message comprising at least the received location information and the received at least one of the audio and image data.

In accordance with yet a further embodiment of the invention there is a computer readable memory storing an emergency service program that when executed by at least one processor results in actions comprising: receiving location information for a calling phone and at least one of audio and image data captured by the calling phone; using a calling phone identifier, which is received with the at least one of the audio and image data, to access a memory storing an association of the calling phone identifier with a called phone identifier to determine the called phone identifier, and sending to the called phone a message comprising at least the received location information and the received at least one of the audio and image data.

These and other aspects are set forth in further detail below.

### BRIEF DESCRIPTION OF THE DRAWINGS

FIG. 1 is a schematic diagram of various nodes in a communication system which are relevant to these teachings.

FIG. 2 is a signaling diagram showing communication through the nodes of FIG. 1 according to an exemplary but non-limiting embodiment of the invention.

FIG. 3 is a schematic diagram showing detail of a mobile terminal and of a server such as those shown at FIG. 1.

### DETAILED DESCRIPTION

The examples below assume that the device which captures the original data stream is a mobile telephone, but in other embodiments the data may be captured by any device having a transducer, a transmitter and a galvanic or other portable power supply. For example, the device may be disguised as a pendant on a necklace, or a wristwatch or bracelet. In various embodiments the transducer is a microphone and/or a camera (capturing still images or video or both).

Consider a non-limiting example. A parent sends their child off to school and after-school extra-curricular activities. Both parent and child have mobile phones for coordinating any schedule changes that may be necessary. It is a parent's great fear that their child might be abducted. One fact adding to this fear is that if a child were abducted, there is often precious little evidence for police to follow except that which found long after it might be helpful in finding the child soon after the abduction.

According to an embodiment of the invention, there is a security application stored in the child's mobile phone that when executed automatically performs multiple steps, including:
a. capturing sound and/or image (still or video) data of the environment in front of the microphone and/or camera lens;
b. determining the geographic location of the phone;
c. wirelessly sending the stream of captured data, along with the geographic location, to a private emergency service which automatically distributes both pieces of information to the parent or to whomever the parent designates; and
d. wirelessly sending updated geographic position data, with or without new sound/image data, which updates may be sent periodically or continuously.

Whether or not the camera captures any useable data (i.e., if the camera remains in the child's pocket with the lens blocked), the mere fact of distributing the phone's geographic location to the parent via the emergency service enables the police to obtain real time location information of the abduction while it is in progress. If also the camera captures an image of the surroundings, they can know whether the child is outdoors or in a vehicle. Any captured audio can be used to know if the abductor is a male or female, and voiceprints from that captured audio as well as any image data of the abductor can be used as evidence with a valid chain of custody once stored at a server controlled by the private emergency service.

Certain safety concerns for the child inform the design of the security application that is resident in the child's phone. First are discussed those related to initiating the security application (i.e., activating the already-stored program). In one embodiment it is initiated by a dedicated physical button or other type of actuator on the mobile phone. To avoid excessive false reports by inadvertent depressing of such a dedicated button, such a button will initiate the security application only when depressed continuously for longer than a predetermined time interval, such as three seconds for example. Alternatively there may be two buttons that need to be simultaneously depressed to initiate the security application.

Apart from being initiated from the child's phone itself, in an embodiment the security application that is resident on the child's phone may be remotely initiated by the private emergency service, as directed for example by a call from the parent's phone. This is potentially valuable for example if the child's whereabouts are unknown but the child is late in arriving at an expected location; after some extended time it is normal for a parent to fear the worst and in this instance the parent can authenticate with the private security service who calls the child's phone and remotely initiates the security application.

Further safety considerations concern operation of the security application after it is initiated. To avoid alerting the abductor that the child's phone is reporting on his/her malfeasance, any one of more of the following may be present in an exemplary embodiment: the camera flash is disabled; backlighting is disabled (i.e., for the display screen, keypad, and anything else); incoming call and data alerts are disabled or may be automatically converted to vibrate-only or some other silent alerting mode; and the graphical display screen remains blanked even when a user input is entered.

Disabling the flash overrides any automatic flash feature that might otherwise activate the flash (i.e., low ambient lighting when the security application turns on the camera). Disabling backlighting terminates the user-selected or default backlight timer and so once the security application is initiated the backlight cannot indicate to the abductor that the phone was recently used. Once the parent receives notification from the emergency service, the parent will likely try to call their child. Disabling any audible alerts from this call helps assure that the abductor is not inadvertently alerted by the parent him/herself, which enables the phone to continue providing updated location information via the security application and private security service. Blanking the display screen helps deceive the abductor into believing the phone might be turned off if s/he sees the phone and handles it themselves, which also enables the updated location information noted above to continue.

For the remote-initiation embodiments, if in fact the child is under duress any audible ring of the child's phone that arises from the call which remotely initiates the security application might alert the child's abductor, who might then disable or dispose of the child's phone. To avoid this, in one exemplary embodiment the security application is automatically initiated remotely when the child's phone senses that a call is incoming from the private security service, and this initiating occurs prior to any audible or visual alert of an incoming call or data (though in an embodiment a vibrate mode is enabled for calls/data incoming from the security service). In this instance the phone number or website from which the call (which may be a voice call or an SMS for example) from the private security service originates is pre-stored in the phonebook of the child's phone, and when a match is found for the incoming call the security application is initiated. This matching is not unusual for common smart-phones which enables them to display the calling party's name, number, photo, or other data from the onboard phonebook when the audible tone for an incoming call is played. In this embodiment that functionality is extended so that the security application is initiated automatically for the case in which there is a match of inbound calling number/website to the private security service stored in the local memory of the child's phone. Since the child's phone is at best vibrating-only to alert the child that the private security service is calling, there may be some instances in which the child is not abducted but does not recognize that the security application has been remotely initiated and so will not call their parent to inform them that no emergency exists. Some parents may find this ‘false’ alarm potential to be acceptable in exchange for the added option of remotely initiating the security application in case it is ever needed in fact.

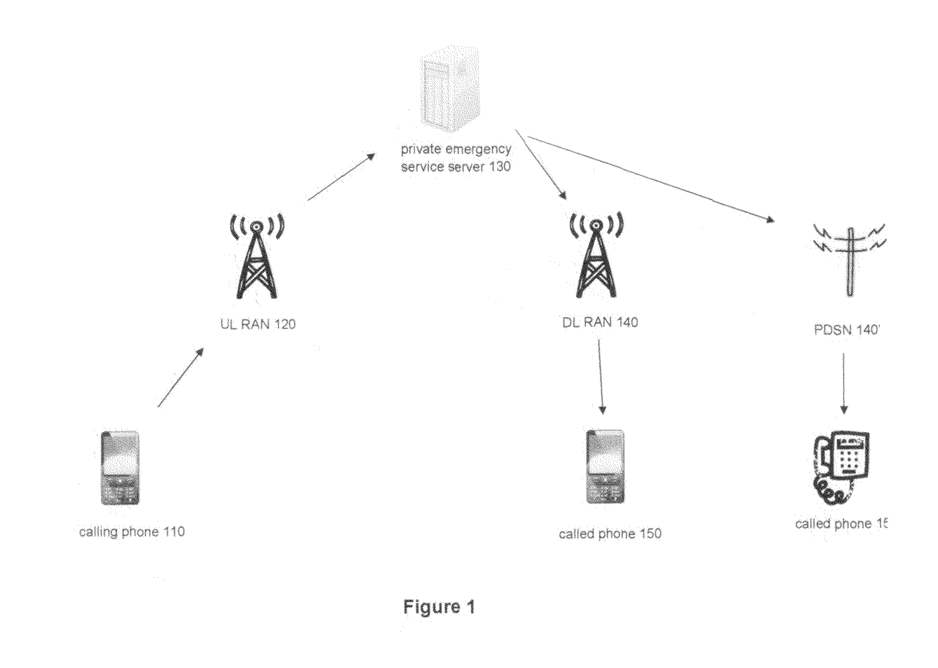

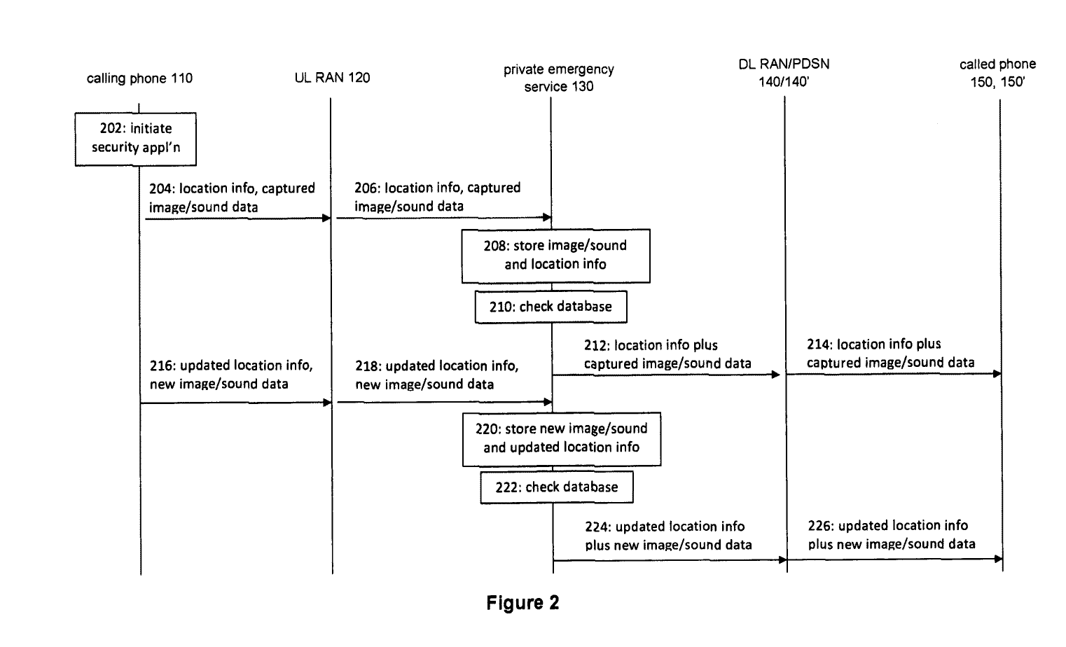

FIG. 1 is a high level schematic diagram showing communication nodes involved in collecting and distributing the information that is captured and assembled as directed by the security application. FIG. 2 is an exemplary but non-limiting signaling diagram showing communication amongst the various nodes of FIG. 1 according to an exemplary embodiment of the invention. These two figures are discussed together with respect to the exemplary but non-limiting embodiment below.

The security application itself is resident in a calling phone 110, which in the above example is the child's phone. At block 202 the security application in the calling phone 110 is initiated, for which a few exemplary implementations are noted above. There is an uplink radio access network UL RAN 120 to which the calling phone 110 has or initiates a wireless link. It is this uplink over which the location information and the captured image/audio are originally sent at message 204 by the calling phone 110. The UL RAN 120 reads the destination address of the message 204 and forwards it at message 206 on to the addressee, which is a server under control of the private emergency service 130. The security application in the calling phone 110 dials a number which goes to the private emergency service 130, which in this case is directly a server in communication over the Internet with the UL RAN 120.

In one exemplary embodiment the UL RAN 120 merely passes the call through from message 202 to message 204 to its intended recipient and in an exemplary embodiment makes no change to the substantive content of the message originating at the calling phone 110. In another exemplary embodiment the UL RAN 120 recognizes that this is an emergency call (i.e., flagged similar to a 911 call) and utilizes network resources to fix a geographic location for the calling party 110, whether or not the uplink message from the calling party 110 includes location information itself (since the UL RAN 120 does not normally open and read the message from the calling party 110).

The message 204 received at the private emergency service server 130 carries also the identifier of the calling phone 110, which can be the phone number of the calling phone 110 or some other identifier. The private emergency service 130 stores 208 the location information and image/sound data it receives, and uses that identifier to access at block 210 a database of its clients stored in a computer readable memory accessible by the server 130. This database associates calling phone identifiers with called phone identifiers in the database. That is, when a customer subscribes to the private security service 130 the customer provides a contact number for emergencies. This is the phone number of the called phone 150, 150′, which is the information the private emergency service 130 extracts from the database by accessing it using the identifier of the calling phone 110.

With that information, the emergency service 130 then places a call to the called phone 150, 150′ which carries the location information of the calling phone 110, the captured image and/or audio which originated at the calling phone 110, and also a timestamp of when that location information was valid. Such a timestamp may conveniently be a timestamp automatically affixed to metadata on the captured image/audio which originated from the calling phone 110. This message sent by the private emergency service 130 is shown at FIG. 2 as 212.

For the case in which the called phone is a cellular terminal 150, the call from the security service 130 routes through a downlink radio access network DL RAN 140. Depending on the relative locations of the calling phone 110 and the mobile terminal called phone 150, the UL RAN 120 may be the same network as the DL RAN 140. For the case in which the called phone 150′ has a landline connection (either directly or through a base unit to which is slaved the cordless called phone), the call from the security service 130 routes through a public switched data network PDSN 140′. In an embodiment the customer of the security service 130 may designate more than one phone number as the called phone 150, 150′, in which case both of the above examples may be included in one embodiment. Regardless, FIG. 2 shows the message received by the called phone 150, 150′ as 214. The DL RAN 140 or PDSN 140′ generally do not change the content of this message 212 before sending it 214 to the called phone 150, 150′.

In an embodiment, the security service 130 does more than simply forward the location information it received from the calling phone 110 but instead puts the location information into a more user-friendly format than that in which it was received. For example, the security service 130 may send 212 to the called phone 150, 150′ the location information in a form that is readily mapped on a geographic map. Such a map may be pre-stored in a memory of the called phone 150, 150 (i.e., in a companion security application stored there) so as to reduce signaling overhead. Alternatively the message 212 from the private emergency service 130 may include rudimentary mapping data so that the display of the called phone 150, 150′ can show the location of the calling phone 110 on a map even if there is no pre-stored map at the called phone 150, 150′. Alternatively, the message 212 may carry the location information in the form of street address and nearest street intersection or distance to intersection so as to avoid having to download voluminous map data, since voluminous wireless data risks the wireless message 214 to the called phone 150, 150′ being delayed or dropped. In any of these embodiments the private security service 130 retains the original granularity of the location information it received at message 206 in case the information it actually sends in its message 212 to the called phone 150, 150′ is not sufficiently precise.

Now having the location information and possibly useful image and/or audio captured at the calling phone 110, the called phone 150, 150′ can elevate the emergency to whatever level the user (which is the parent in the above example) sees fit. The parent can notify police immediately, or knowing where his/her child is supposed to be the parent may try to contact the child by other means or via the calling phone 110 itself. If notifying the police, the location information and captured image/audio data is already in the called phone 150, 150′ and available for further distribution from the called phone 150, 150′ as necessary.

At this juncture the location information is typically at most a few minutes old. In the event of an actual abduction, one might imagine the abductor would prefer to move the child from the location of the initial abduction. Consequently, after being initiated and until being terminated, the security application on the child's phone sends updated location information and newly captured image/audio data as before. Such updated location information is sent periodically. This is shown at FIG. 2 similar to distribution of the original location information, recognizing that the UL RAN 120 and/or DL RAN 140 may or may not be the same as those which passed the original location information, depending on whether and how far the calling phone 110 and/or the called phone 150 have physically moved in the interim.

Specifically, the calling phone 110 determines updated location information of itself according to some predetermined periodic interval, actuates its camera to capture new image data and/or actuates its microphone to capture new audio data, and wirelessly sends it at message 216 to the pre-determined private emergency service via the UL RAN 120 which passes the message on at 218.

The private emergency service 130 stores the new image data and/or new audio data with timestamps at block 220, uses the calling phone identifier which was received in message 218 to check the database at 222 to determine the called phone identifier, and sends at message 224 to the called phone 150, 150′ an update message comprising the received updated location information and the new image data and/or the new audio data. Depending on where the called phone 150, 150′ is located, that message 224 goes to the DL RAN 140 or the PDSN 140′ and those nodes forward the message to the called phone 150, 150′ which is the addressee.

In an embodiment the extent of the update period varies based on speed of movement; when the location is fast-changing the location updates are sent more frequently than if the location is stable or slowly changing. The companion security application stored in the called phone 150, 150′ knows the speeds for the various periodic updates, and so after each update of location information can compute a radius within which the calling phone 110 must be located, assuming its speed has not increased. In the event the calling phone 110 cannot obtain a workable link with the UL RAN 120 at the time it is scheduled to send a location update, it timestamps the location update its has stored in its memory and sends it when a link is obtained. If several such timestamped location updates are stored locally in the calling phone 110 prior to a use-able link being obtained, in an embodiment the calling phone 110 sends each such timestamped location update so that the companion security application at the called phone 150, 150′ can have the information to compute the path by which the calling phone passed to get to its most recent location. The timestamps are of course metadata and transferred in the various messages with the underlying substantive image/audio data.

In various exemplary embodiments of the invention, the calling phone 110 determines its own location information and sends it as shown at FIG. 2. By example such a calling phone 110 can determine its own location information via a global positioning system GPS receiver, or an internal inertial navigation system (i.e., ring laser gyros), or estimates its position by triangulating or other interpolation method using signals from multiple cellular base stations. By example, such position estimating may use received signal strength of signals broadcast from one or more base stations, and estimate speed and direction of the calling phone 110 based on difference in a rate of change in signal strength of those received signals.

In other exemplary embodiments of the invention, the calling phone 110 does not have the capability to determine its own location information and so it sends the captured image/audio without any location information in its uplink message to the UL RAN 120. But in this embodiment the security application also indicates directly to the UL RAN 120 that there is an emergency, for example an indicator in the uplink message 204 carrying the captured image/audio data or calling also a public emergency number (i.e. 911 in the US) in addition to the data message 204. Either of these implementations alerts the UL RAN 120 to determine the location of the calling phone 110 using networks own resources. In these embodiments the UL RAN 120 can determine the location information by triangulating similar to that detailed above for the calling phone 110. The UL RAN 120 then sends the location information to public emergency services such as a 911 operator who forwards the location information to the relevant emergency responders.

The emergency service 130 receives the message from the calling phone 110 which lacks location information, but the emergency service 130 knows the identity of the UL RAN 120 from the packet routing information. In one embodiment the emergency service 130 contacts the UL RAN 120 and requests that it forward the location information of the emergency service 130. In another embodiment the emergency service 130 contacts the 911 operator directly, informs the 911 operator that the emergency service has additional information on the calling phone 110 and requests the location information which was provided by the UL RAN 120. In either case the emergency service 130 is able to obtain the location information for the calling phone 110, which it sends to the called phone 150, 150′ as previously noted, though in this case it may be sent separate from the captured image/audio data that originated from the calling phone 110. The message to the called phone 150, 150′ may additionally have information about the 911 operator which has already been contacted, to enable the parent user of the called phone 150, 150′ to contact them directly.

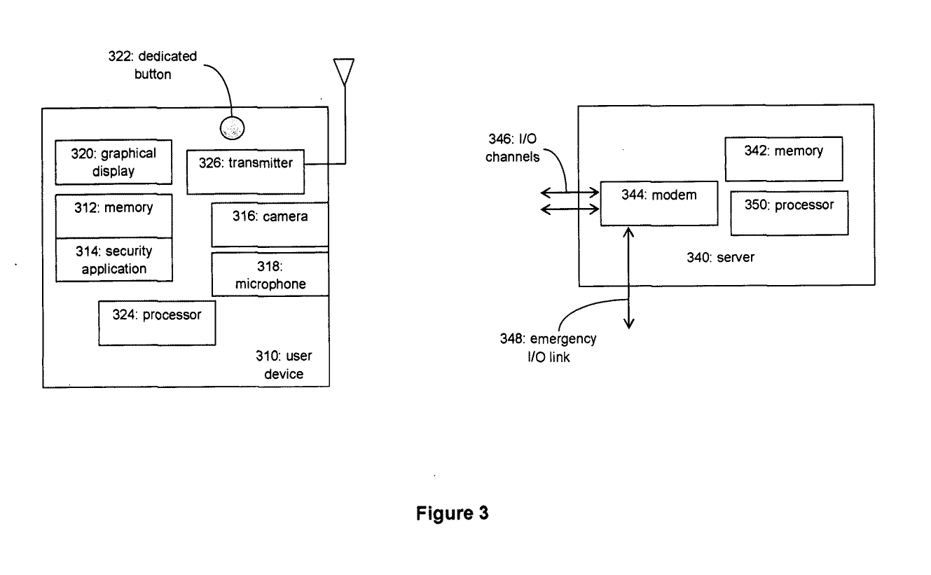

Refer to FIG. 3 for a simplified block diagram of various electronic devices and apparatus that are suitable for use in practicing the exemplary embodiments of this invention. In FIG. 3 there is a user device 310 in the position of the calling phone detailed above. The user device 310 includes a memory 312 storing the security application 314 and other computer readable programs. The device 310 also includes a camera 316 for capturing image data (stills and/or video), a microphone 318 for capturing audio data, a graphical display 320 which is backlit and a dedicated button 322. All of these components are under control of one or more processors 324. Messages sent from the device 310 wirelessly are sent via a transmitter 326 and one or more antennas 328.

The private security service 130 has at least one server 340 which includes a memory 342 storing the database detailed above, a modem 344 for modulating and demodulating various signals and messages that arrive and are sent via multiple input/output channels 346. There may also be an emergency I/O link 348 for direct contact with a public emergency operator such as a 911 operator. All these components are under control of one or more processors 350.

The computer readable memories 312, 342 may be of any of the various data storage technology types known or yet to be developed, including but not limited to flash memory, semiconductor based memory devices, magnetic memory, optical memory, fixed memory, and removable memory, and at least for the server 340 an arrayed memory arrangement. The processors 324, 350 may include but are not limited to one or more microprocessors, signal processors, and general purpose processors.

Various modifications and adaptations to the above exemplary embodiments may become apparent to those skilled in the relevant art in view of the above description when read in conjunction with the accompanying drawings. Any and all such modifications fall within the scope of the ensuing claims unless specifically excluded from such claims. Furthermore, the above description is merely illustrative of the principles, teachings and exemplary embodiments of this invention, and not in and of themselves a limitation thereof.

We claim:

1. A method for operating a portable electronic device comprising:
in response to a security application stored in a memory of the portable electronic device being initiated:
determining location information of the device;
actuating at least one of a microphone and a camera of the device to capture at least one of audio and image data; and
wirelessly sending to a pre-determined emergency service the location information and the captured at least one audio and image data.

2. The method according to claim 1, in which the security application is initiated by a single user input at a user interface of the device.

3. The method according to claim 1, further comprising, in response to the security application being initiated, at least one of:
disabling a flash associated with the camera;
disabling a backlight of a user interface of the device;
disabling at least audible alerts at the device for incoming calls and data;
blanking a graphical display screen of the device.

4. The method according to claim 3, in which in response to the security application being initiated at least audible alerts at the device for incoming calls and data are disabled;
further in which the security application is initiated by receipt of an incoming call or data from a predetermined sender, and the audible alerts are disabled according to the security application prior to any audible alert from the said incoming call or data.

5. A computer readable memory storing a security application that when initiated result in the security application being executed by at least one processor, and the executed security application results in actions comprising:
determining location information of a host device storing the memory;
actuating at least one of a microphone and a camera of the host device to capture at least one of audio and image data; and
wirelessly sending to a pre-determined emergency service the location information and the captured at least one of audio and image data.

6. The computer readable memory according to claim 5, in which the security application is initiated by a single user input at a user interface of the host device.

7. The computer readable memory according to claim 4, in which the executed security application results in further actions comprising at least one of:
disabling a flash associated with the camera;
disabling a backlight of a user interface of the host device;
disabling at least audible alerts at the host device for incoming calls and data;
blanking a graphical display screen of the host device.

8. The computer readable memory according to claim 7, in which the executed security application results in disabling audible alerts at the device for incoming calls and data;
further in which the security application is initiated by receipt of an incoming call or data from a predetermined sender, and the audible alerts are disabled according to the security application prior to any audible alert from the said incoming call or data.

9. The computer readable memory according to claim 5, in which the executed security application results in further actions comprising:
determining updated location information of the host device according to predetermined periodic intervals;
at least one of actuating the camera to capture new image data or actuating the microphone to capture new audio data; and
wirelessly sending to the pre-determined emergency service the updated location information and the at least one of new image data and new audio data.

10. A method for operating a private emergency service using at least one server, comprising:
storing in a computer readable memory accessible by the at least one server an association of a calling phone identifier with a called phone identifier;
the at least one server receiving location information for the calling phone and at least one of audio and image data captured by the calling phone;
the at least one server using the calling phone identifier which is received with at least the image data to access the memory and determine the called phone identifier, and
the at least one server sending to the called phone a message comprising at least the received location information and the received at least one of audio and image data.

11. The method according to claim 10, in which the location information and the at least one of audio and image data are received in a single message which bears the calling phone identifier.

12. The method according to claim 10, in which the location information is received from one of a radio access network and a public emergency services operator in response to a query sent from the at least one server in response to receiving the image data.

13. The method according to claim 10, further comprising:
the at least one server receiving updated location information of the calling phone, and at least one of new image data and new audio data captured by the calling phone, according to a predetermined periodic interval;
the at least one server using the calling phone identifier, which is received with at least the said one of new image data and new audio data, to access the memory and determine the called phone identifier, and
the at least one server sending to the called phone an update message comprising at least the received updated location information and the said at least one of the new image data and the new audio data.

14. The method according to claim 10, in which the message comprises an indicator that flags the message as an emergency message.

15. The method according to claim 10, in which the location information for the calling phone and the at least one of the audio and image data captured by the calling phone is received in response to sending to the calling phone a message to remotely initiate a security application resident on a local memory of the calling phone.

16. A computer readable memory storing an emergency service program that when executed by at least one processor results in actions comprising:
receiving location information for a calling phone and at least one of audio and image data captured by the calling phone;
using a calling phone identifier, which is received with the at least one of the audio and image data, to access a memory storing an association of the calling phone identifier with a called phone identifier to determine the called phone identifier; and
sending to the called phone a message comprising at least the received location information and the received at least one of audio and image data.

17. The computer readable memory according to claim 16, in which the location information and the at least one of audio and image data are received in a single message which bears the calling phone identifier.

18. The computer readable memory according to claim 16, in which the location information is received from one of a radio access network and a public emergency services operator in response to a query sent in response to receiving the image data.

19. The computer readable memory according to claim 16, the actions further comprising:
receiving updated location information of the calling phone, and at least one of new image data and new audio data captured by the calling phone, according to a predetermined periodic interval;
using the calling phone identifier, which is received with at least the said one of new image data and new audio data, to access the memory and determine the called phone identifier; and
sending to the called phone an update message comprising at least the received updated location information and said at least one of the new image data and the new audio data.

20. The computer readable memory according to claim 16, in which the message comprises an indicator that flags the message as an emergency message.
